(19) United States
(12) Patent Application Publication
(10) Pub. No.: US 2024/0045567 A1
(43) Pub. Date: Feb. 8, 2024

(54) TRACKING CHANGES TO DATA FIELDS OF A USER INTERFACE

(71) Applicant: Salesforce, Inc., San Francisco, CA (US)

(72) Inventors: Jose LEJIN PJ, Bengaluru (IN); Ramanjaneyulu Y. TALLA, Bangalore (IN)

(73) Assignee: Salesforce, Inc., San Francisco, CA (US)

(21) Appl. No.: 17/882,276

(22) Filed: Aug. 5, 2022

(51) Int. Cl. G06F 3/0482; G06F 8/38

(52) U.S. Cl. CPC G06F 3/0482; G06F 8/38

(57) ABSTRACT

A user device may identify data in a data field of a user interface and generate a changed fields window of the user interface to track changes to the data in the data field. Data in a data field of the changed fields window may correspond to the data in the data field. An indicator element may be displayed, for example, based on an interaction with the data in the data field of the changed fields window. The indicator element may indicate correspondence between the changed data in the data field and the data in the data field of the changed fields window. The indicator element may be displayed as an overlay of at least a portion of the user interface. Moreover, an inaccessible fields window including data fields that are no longer applicable in the current view of the user interface may be generated.

### BACKGROUND

Web applications, user interfaces (UI), are used to manage data for specific intents, for example, such as data used to configure network management devices, cloud-based systems (e.g., software as a service (SaaS) systems/components, etc.), and/or private/public networks. Data, such as configuration information, to implement a specific intent is routinely complex and often includes a large number of input elements that are input to fields of a web application and/or user interface. When submitting such data into various fields of a web application and/or user interface, a user may change previous values/data in various fields to new values/data (e.g., inputs). A significant amount of changes between previous values/data to new values/data in fields may lead to confusion.

When managing data via a complex (e.g., comprising multiple data fields with varying dependencies, etc.) web application and/or user interface forms and/or pages, it can be difficult to track all changes between previous values/data to new values/data in fields, for example. Fields that complement other fields and/or have other fields that depend on their respective value/data may no longer be applicable or may disappear from a complex and/or long web application and/or user interface once data is input to the fields. For example, for a configuration form where data is input to a field to change a protocol from Hypertext Transfer Protocol Secure (HTTPS) to Hypertext Transfer Protocol (HTTP), a data field associated with a Secure Sockets Layer (SSL) certificate may no longer be applicable or may disappear from the configuration form. For fields that complement other fields and/or have other fields that depend on their respective value/data, once the fields are no longer applicable and/or no longer appear on a web application and/or user interface, it is difficult (if even possible) to identify what the previous data in the fields was before any change was made.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 shows an example system for tracking changes to data fields of a user interface, according to some aspects.

FIG. 2A shows an example of a user interface, according to some aspects.

FIG. 2B shows an example of a user interface where previous data from a changed data field is presented in a changed fields window, according to some aspects.

FIG. 2C shows an example of a user interface where previous data from a changed data field is presented in a changed fields window and data fields rendered inaccessible by the changed data field are resented in an inaccessible fields window, according to some aspects.

FIG. 3 shows an example communication diagram for tracking changes to data fields of a user interface, according to some aspects.

FIG. 4 shows a flowchart of an example method for tracking changes to data fields of a user interface, according to some aspects.

FIG. 5 shows a schematic block diagram of an example computer system in which aspects described may be implemented.

### DETAILED DESCRIPTION

Provided herein are system, apparatus, device, method, computer program product embodiments, and/or combinations and sub-combinations thereof, for tracking changes to data fields of a user interface. A user device (e.g., a computing device, a smart device, a mobile device, a laptop, a tablet, a set-top box, a display device, etc.) may generate and/or display a user interface (e.g., a configuration form/interface, a web form, a web page, an application page, a data form, etc.). The user interface, for example, a current view, screen, page, form, and/or the like of the user interface may include various data fields (e.g., form fields, input elements, etc.). According to some aspects, the user device may facilitate and/or implement tracking of changes to data fields of a user interface by generating a changed fields window (e.g., a pop-up window, a block, an interface of any shape, a specialized pop-up window/block, etc.) that includes a previous representation (e.g., copy, reflection, presentation, etc.) of data fields of the user interface and/or data within the data fields whenever a change is made to the data fields and/or the data within the data fields.

The system, apparatus, device, method, computer program product embodiments, and/or combinations and sub-combinations thereof described herein provide an indication of what all (e.g., data fields, etc.) is changed in a current view, screen, page, form, and/or the like of the user interface, and/or the order/sequence in which changes are made. Data fields that complement other data fields and/or have other data fields that depend on their respective value/data that may no longer be applicable and/or may disappear from a current view, screen, page, form, and/or the like of the user interface once data is input to the data fields may be identified and represented in a window of the user interface. According to some aspects, an indicator element may be generated to provide a clear indication of a data field with changed data that is presented by a current view, screen, page, form, and/or the like of a user interface, and a previous representation of the data field (e.g., before any changes, etc.). As described herein, a changed fields window and/or the like is a tool that helps users easily reference changes to data input to data fields and/or any subsequent and/or corresponding changes to the view, screen, page, form, and/or the like of a user interface without the expense of computation resources, excess time, bad usability, and/or the opportunity for error associated with manually recalling and/or remembering data fields or data input into the data fields. These and other technological advantages are described herein.

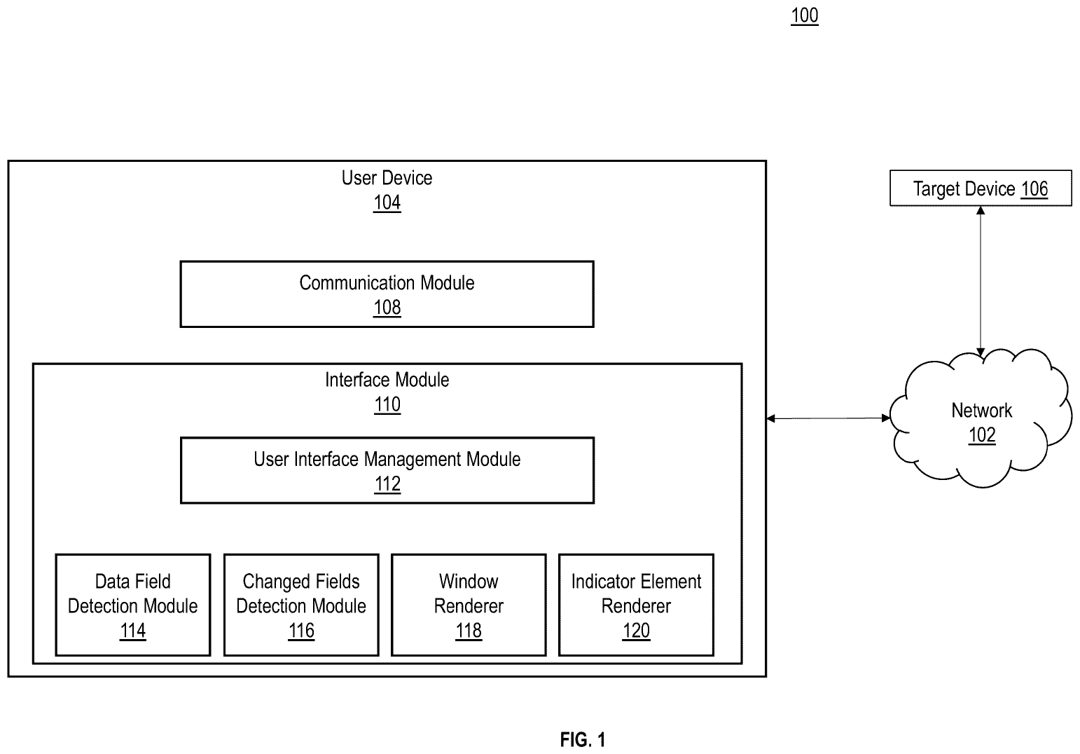

FIG. 1 shows an example system 100 for tracking changes to data fields of a user interface. The system 100 is merely an example of one suitable system environment and is not intended to suggest any limitation as to the scope of use or functionality of aspects described herein. Neither should the system 100 be interpreted as having any dependency or requirement related to any single module/component or combination of modules/components described therein.

The system 100 may include a network 102. The network 102 may include a packet-switched network (e.g., internet protocol-based network), a non-packet switched network (e.g., quadrature amplitude modulation-based network), and/or the like. The network 102 may include network adapters, switches, routers, modems, and the like connected through wireless links (e.g., radiofrequency, satellite) and/or physical links (e.g., fiber optic cable, coaxial cable, Ethernet cable, or a combination thereof). The network 102 may include public networks, private networks, wide area networks (e.g., Internet), local area networks, and/or the like. The network 102 may include a content access network, content distribution network, and/or the like. The network 102 may provide and/or support communication from telephone, cellular, modem, and/or other electronic devices to and throughout the system 100. For example, the system 100 may include a user device 104 in communication with a target device 106 via the network 102.

According to some aspects, the user device 104 may include, for example, a smart device, a mobile device, a laptop, a tablet, a display device, a computing device, or any other device capable of communicating with the target device 106. The user device 104 may include a communication module 108 that facilitates and/or enables communication with the network 102 (e.g., devices, components, and/or systems of the network 102, etc.), the target device 106, and/or any other device/component of the system 100. For example, the communication module 108 may include hardware and/or software to facilitate communication. The communication module 108 may comprise one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. The communication module 108 may include any hardware and/or software to facilitate communication.

According to some aspects, the user device 104 may include an interface module 110. The interface module 110 enables a user to interact with the user device 104, the network 102, the target device 106, and/or any other device/component of the system 100. The interface module 110 may include any interface for presenting and/or receiving information to/from a user.

The target device 106 may include a computing device, a network device, a cloud-based device/component, an Internet-of-Things (IoT) device, a smart device, a system device, and/or any other type of device and/or system component. According to some aspects, the target device 106 may be any device, network, and/or system that may be configured by the user device 104, for example, via a user interface management module 112.

According to some aspects, the interface module 110 may include the user interface management module 112. The user interface management module 112 enables a user to view web application documentation and/or content, application pages, webpages, and/or any other page of a multipage user interface. For example, the user interface management module 112 may be used to access and/or view pages and/or the like of an application configured with, and/or accessible by the user device 104. The user interface management module 112 may be used to access various data fields presented on various views, screens, pages, forms, and/or the like of a user interface (e.g., the interface module, etc.) generated by, configured with, and/or accessible by the user device 104.

According to some aspects, the user interface management module 112 may include a web browser. The user interface management module 112 may request/query and/or send/provide various files from a local source and/or a remote source, such as the target device 106, and/or the like. The user interface management module 112 may access, process, and view information, web forms, web pages, and/or applications available to it from the system 100 via the network 102.

According to some aspects, the interface module 110 may include one or more input devices and/or components, for example, such as a keyboard, a pointing device (e.g., a computer mouse, remote control), a microphone, a joystick, a tactile input device (e.g., touch screen, gloves, etc.), and/or the like. According to some aspects, interaction with the input devices and/or components may enable a user to view, access, request, and/or navigate a user interface generated and/or displayed by the interface module 110 and/or accessible via the user interface management module 112. According to some aspects, interaction with the input devices and/or components may enable a user to manipulate and/or interact with components of a user interface, for example, such as data fields, interactive elements, windows (e.g., changed fields windows, inaccessible fields windows, any pop-up window/block, specialized pop-up windows/blocks, etc.), and/or the like.

According to some aspects, the interface module 110 may include a data field detection module 114. The data field detection module 114 may detect and/or identify data fields (and/or any other type of field or component, etc.) of a user interface, such as a complex form used to configure the target device 106 and/or any other user interface. For example, the data field detection module 114 may perform code/script analysis (e.g., JavaScript analysis, etc.), form field recognition, and/or any other technique to detect and/or identify data fields (and/or data within the data fields) of a user interface.

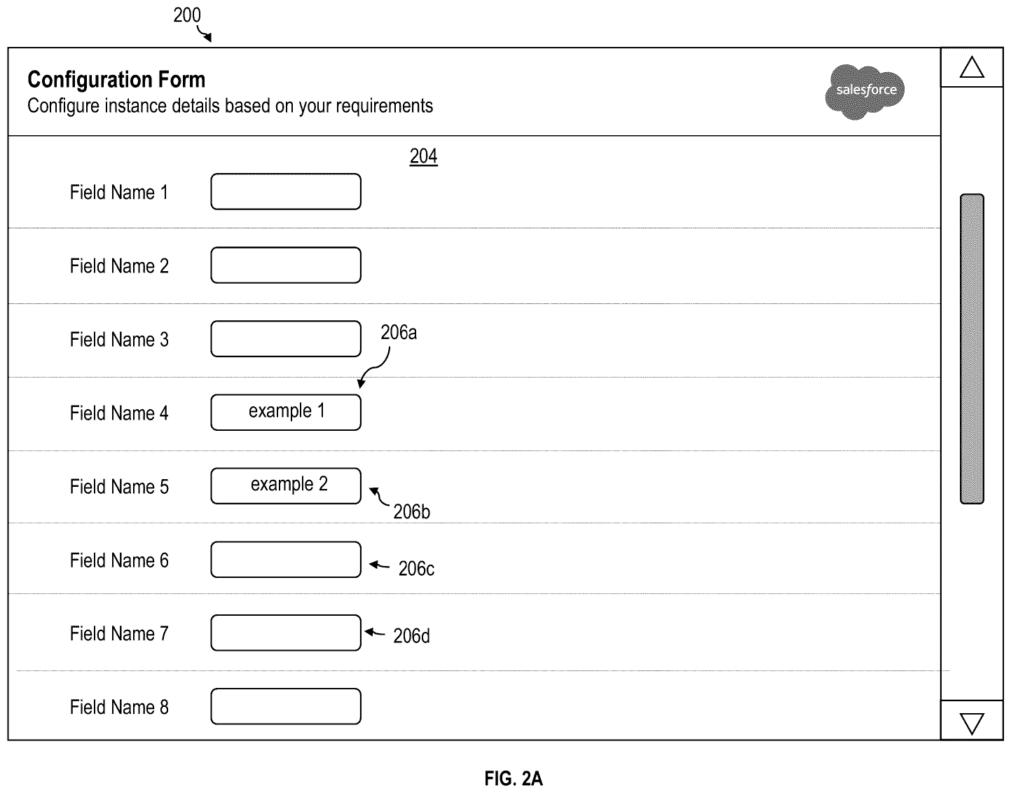

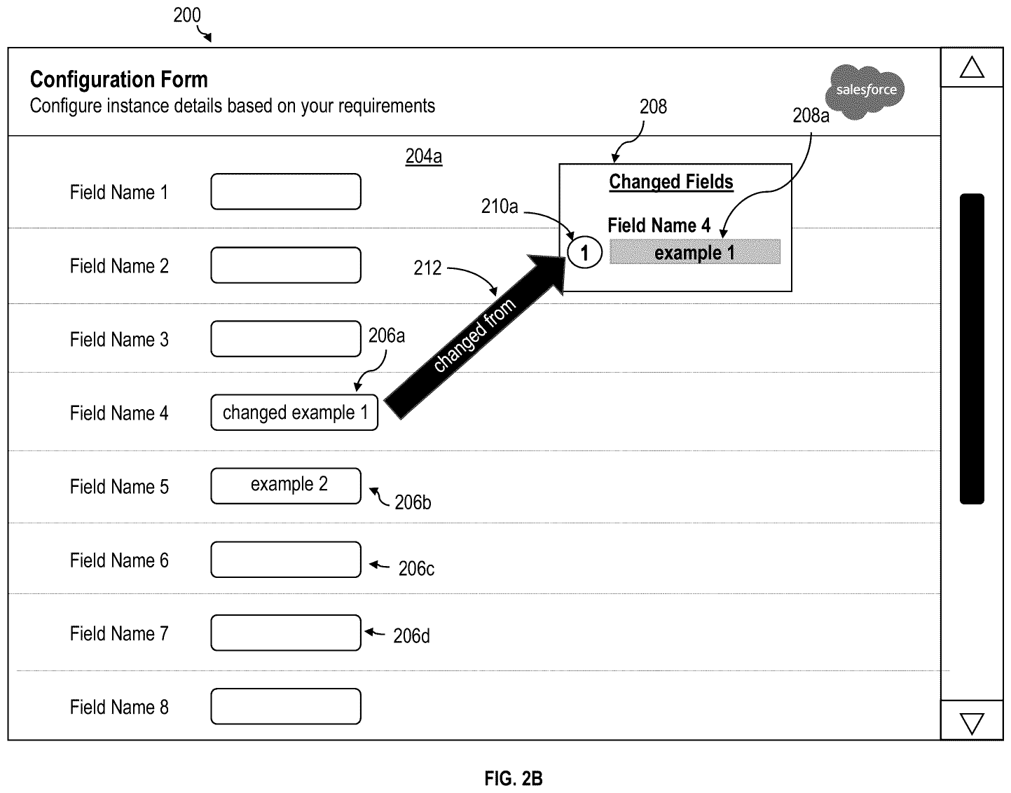

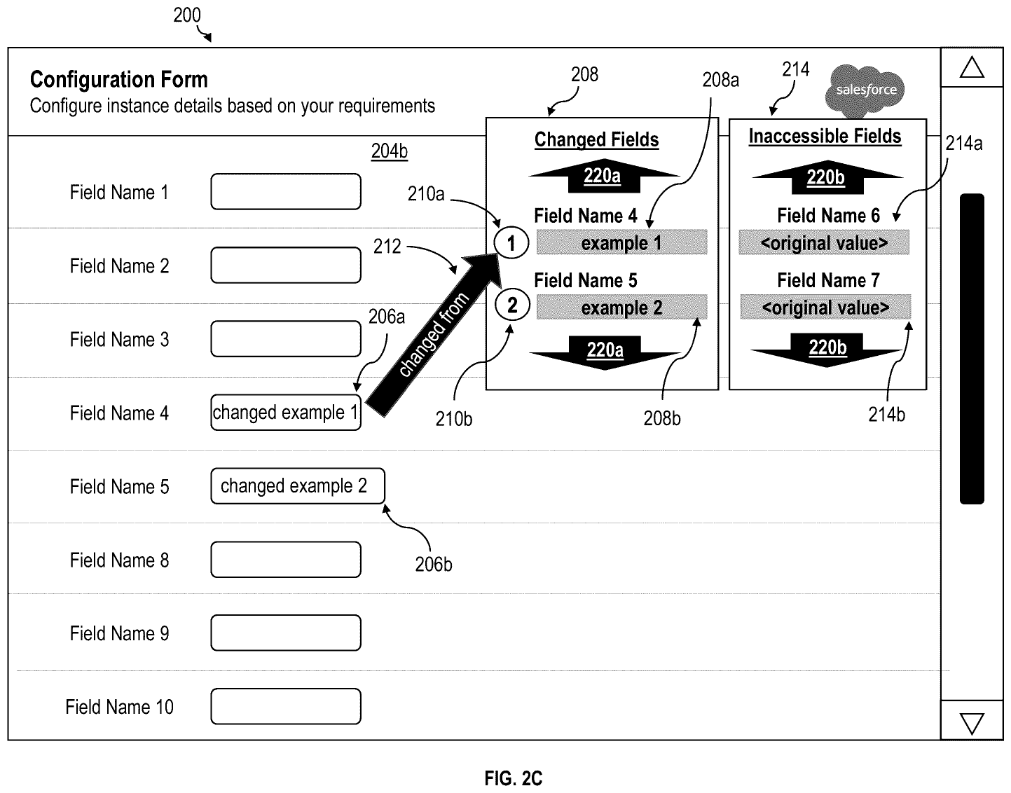

FIG. 2A shows an example of a user interface 200 generated, accessed, and/or displayed by the interface module 110. The user interface 200 may present and/or display a view 204. According to some aspects, the view 204 may be a view, screen, page, form, and/or the like of the user interface 200. The view 204 may include a plurality of data fields, for example, such as data fields 206a, 206b, 206c, and 206d. According to some aspects, some data fields of the user interface 200 may include prefilled data, previously stored data, previously filled data, default data, and/or the like. For example, data field 206a may include “example 1” and 206b may include “example 2” as prefilled data, previously stored data, previously filled data, default data, and/or the like. As described, the data field detection module 114 may code/script analysis, form field recognition, and/or any other technique to detect and/or identify data fields (e.g., data fields 206a, 206b, 206c, 206d, etc.) of the user interface 202 and/or data (e.g., “example 1,” “example 2,” etc.) within the data fields.

Returning to FIG. 1, according to some aspects, the data field detection module 114 may communicate with a changed fields detection module 116 of the interface module 110. The data field detection module 114 may communicate data/information indicative of each data field (and/or data within the data fields) of a user interface (e.g., user interface 200, etc.), for example, such as a complex form used to configure the target device 106 and/or the like. According to some aspects, the changed fields detection module 116 may store the values of all data fields of a user interface. For example, the changed fields detection module 116 may store the values of all data fields of a user interface in a current context memory and/or the like. The changed fields detection module 116 may store the values of all data fields of a user interface in any storage medium including, but not limited to, local storage and remote storage.

According to some aspects, the changed fields detection module 116 may include and/or encode event listeners that listen for and/or monitor events associated with a user interface. For example, the changed fields detection module 116 may include and/or encode event listeners that listen for and/or monitor events such as a changed value and/or element of a data field and/or the like. According to some aspects, the event listeners may detect any change to a current view, screen, page, form, and/or the like of a user interface, and the changed fields detection module 116 may store and/or record the order/sequence in which changes are made. According to some aspects, the changed fields detection module 116 may inform components of the interface module 110, such as a window renderer 118 and/or the like, whenever a change is made to a user interface including, but not limited to, changes to data fields and/or data/values within data fields.

According to some aspects, the window renderer 118 may generate windows, blocks, interfaces of any shape, specialized pop-up windows/blocks, and/or the like for a user interface that include data/information indicative of changes to a view, screen, page, form, and/or the like of the user interface. For example, the window renderer 118 may generate a changed fields window (e.g., a specialized pop-up window, etc.) that is displayed on a current view, screen, page, form, and/or the like of a user interface. The changed fields window may include a previous (e.g., before a change, etc.) representation (e.g., copy, presentation, etc.) of data fields of the user interface and/or data within the data fields whenever a change is made to the data fields and/or the data within the data fields.

According to some aspects, the interface module 110 may include an indicator element renderer 120. The window renderer 118 may communicate with and/or notify the indicator element renderer 120 whenever a changed fields window is generated and/or rendered. The indicator element renderer 120 may generate, render, and/or cause the display of an indicator element (e.g., an arrow, a dotted line, etc.) that indicates correspondence between a data field of a user interface and a data field of the changed fields window.

According to some aspects, the indicator element renderer 120 uses scalable vector graphics (SVG) and/or the like to generate, render, and/or cause the display of an indicator element (e.g., an arrow, a dotted line, a textual element, etc.) that indicates correspondence between a data field of a user interface and a data field of the changed fields window. According to some aspects, an indicator element may overlay a user interface and event listeners may be used to detect, determine, and/or identify whenever a location/position of a data field of the user interface changes.

According to some aspects, whenever event listeners detect, determine, and/or identify a location/position of a data field of the user interface changes, the indicator element renderer 120 may adjust the indicator element to the changed location/position. For example, according to some aspects, the indicator element renderer 120 may use indications from event listeners to adjust and/or correct an angle of connection between a data field of a user interface and a data field of a changed fields window caused by a scroll (e.g., scroll up, scroll down, scroll left, scroll right, etc.), view/screen adjustment, and/or the like of the user interface.

FIG. 2B shows an example of the user interface 200 where a changed fields window is displayed to show a previous representation of a changed data field. The user interface 200 displays a changed fields window 208. The changed fields window 208 is displayed, for example, based on a change to the earlier data (e.g., “example 1”) in the data field 206a to the current data (e.g., “changed example 1”) shown in a current view 204a (view 204) of the user interface 200. As shown, data field 208a of the changed fields window 208 is a previous representation (e.g., copy, reflection, presentation, as shown in FIG. 2A, etc.) of data field 206a.

According to some aspects, the changed fields window 208 may include a sequencing element 210a associated with the data field 208a. The sequencing element 210a may indicate a sequence and/or order of when the change to the data field 206a occurs. For example, sequencing element 210a indicates that the change to the data field 206a is the first change to data fields of the view 204 of the user interface 200. An indicator element 212 indicates correspondence between the data field 206a and the data field 208a of the changed fields window 208.

Returning to FIG. 1, according to some aspects, the window renderer 118 may append a data field to a changed fields window for each changed data field of the user interface. As described, the appended data field may be a previous representation of the changed data field. According to some aspects, data fields appended to a changed fields window may be arranged in a sequence that reflects an order in which corresponding fields of a user interface are changed.

According to some aspects, the changed fields detection module 116 may identify, store, and/or record any data field that complements other data fields and/or has other data fields that depend on their respective value/data. Data fields that depend on the value/data of other data fields may no longer be applicable and/or may disappear from a current view, screen, page, form, and/or the like of a user interface once data is input to the other data fields. The changed fields detection module 116 may inform the window renderer 118 whenever data fields that depend on the value/data of other data fields are no longer applicable, have become read-only (and/or the like), and/or disappear from a current view, screen, page, form, and/or the like of a user interface, for example, once data is input to the other data fields.

According to some aspects, the window renderer 118 may generate an inaccessible fields window (e.g., a pop-up window, a block, an interface of any shape, a specialized pop-up window/block, etc.) that is displayed on a current view, screen, page, form, and/or the like of a user interface. The inaccessible fields window may include data fields representative of data fields that depend on the value/data of other data fields that are no longer applicable, have become read-only (and/or the like), and/or have disappeared from a current view, screen, page, form, and/or the like of a user interface, for example, once data is input to the other data fields.

FIG. 2C shows an example of the user interface 200 where an inaccessible fields window is displayed to show data fields that have been rendered inaccessible based on a change to a data field (or data within the data field). According to some aspects, as shown, the changed fields window 208 includes a data field 208b. The changed fields window 208 includes the data field 208b based on a change to the earlier data (e.g., “example 2”) in the data field 206b to the current data (e.g., “changed example 2”) shown in a current view 204b (view 204) of the user interface 200. As shown, data field 208b of the changed fields window 208 is a previous representation (e.g., copy, reflection, presentation, as shown in FIGS. 2A-2B, etc.) of data field 206b.

According to some aspects, the changed fields window 208 may include a sequencing element 210b associated with the data field 208b. The sequencing element 210b may indicate a sequence and/or order of when the change to the data field 206b occurs. For example, sequencing element 210b indicates that the change to the data field 206b is the second change to data fields of the view 204 of the user interface 200.

According to some aspects, the user interface 200 displays an inaccessible fields window 214. The inaccessible fields window 214 is displayed, for example, based on the change of the earlier data (e.g., “example 2”) in the data field 206b to the current data (e.g., “changed example 2”) shown in a current view 204b (view 204) of the user interface 200 also causing data fields 206c and 206d (e.g., shown in FIGS. 2A and 2B) to disappear from the view 204 (e.g., become inaccessible, etc.). According to some aspects, as shown, data fields 214a and 214b of the inaccessible fields window 214 are previous representations (e.g., copies, reflections, presentations, as shown in FIG. 2A, etc.) of the data fields 206c and 206d.

According to some aspects, the window renderer 118 may generate, render, and/or present a scrollable element for a changed fields window and/or an inaccessible fields window. For example, the window renderer 118 may generate a scrollable elements 220a and 220b for the changed fields window 208 and the inaccessible fields window 214, respectively, based on the amount of fields of the changed fields window 208 and the inaccessible fields window 214 exceeding field display thresholds for the changed fields window 208 and the inaccessible fields window 214. The scrollable elements 220a and 220b may include, for example, a scroll bar, a directional arrow(s), a graphical indicator, and/or the like. The window renderer 118 causes additional data fields and/or overflow fields (e.g., fields that do not fix within a viewable area, etc.) to be displayed within the changed fields window 208 and/or the inaccessible fields window 214 based on an interaction with the scrollable elements 220a and 220b.

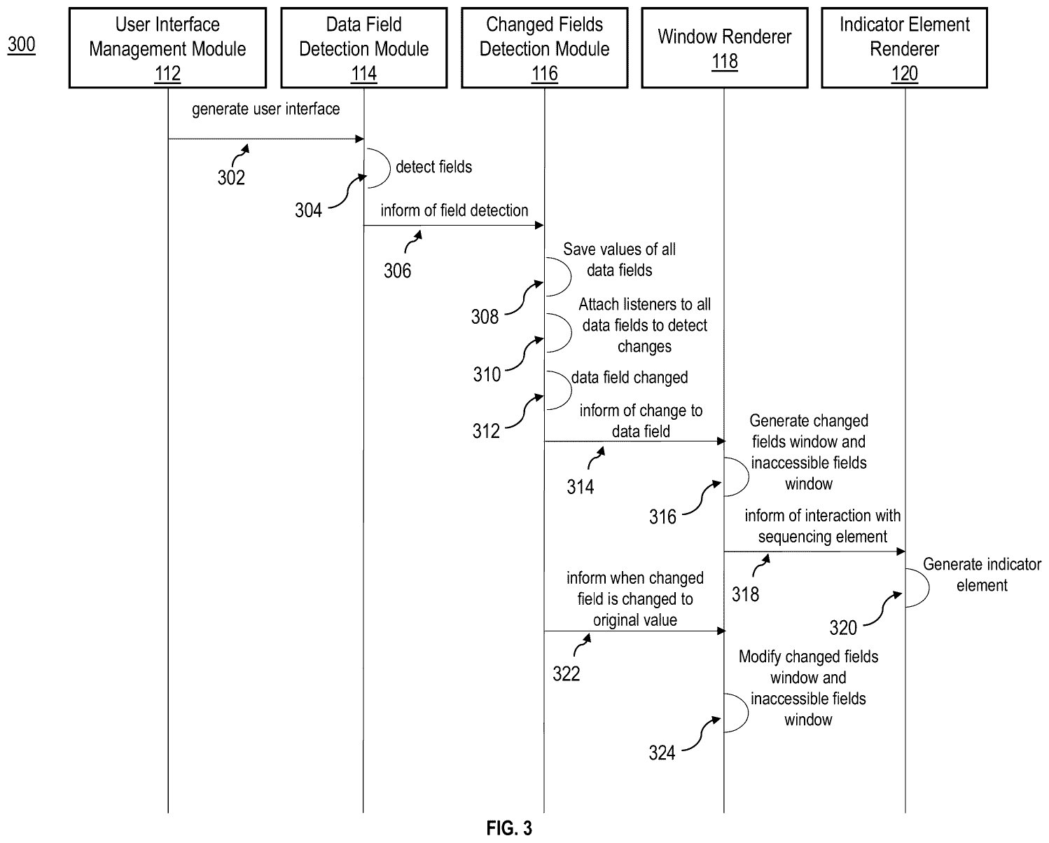

According to some aspects, FIG. 3 shows an example communication diagram 300 for tracking changes to data fields of a user interface. The communication diagram 300 depicts communications between and/or actions performed by components of the user device 104 of FIG. 1, such as the user interface management module 112, the data field detection module 114, the changed fields detection module 116, the window renderer 118, and the indicator element renderer 120. The communications between and/or actions performed by components of the user device 104 enable a user to view changes to data fields and/or data within data fields of a user interface.

In 302, the user interface management module 112 facilitates navigation to a view, screen, page, form, and/or the like of a user interface. For example, the user interface management module 112 generates, launches, and/or causes to be displayed in a user interface. The interface may be, for example, a complex form used to configure a target device and/or the like. The user interface may include a plurality of data fields to which data and/or information may be input.

In 304, the data field detection module 114 detects, identifies, and/or identifies each data field of the user interface.

In 306, the data field detection module 114 informs the changed fields detection module 116 of data fields detected, identified, and/or determined for the user interface.

In 308, the changed fields detection module 116 saves/stores the values of all data fields of the user interface. For example, the changed fields detection module 116 stores the values of all data fields of the user interface in a current context memory and/or the like. The changed fields detection module 116 may store the values of all data fields of a user interface in any storage medium including, but not limited to, local storage and remote storage.

In 310, the changed fields detection module 116 attaches (e.g., associates, encodes, etc.) event listeners that monitor all data fields of the user interface for changes (e.g., changed data values, data fields rendered inaccessible and/or read-only, etc.).

In 312, a data field (e.g., data within a data field, etc.) of the user interface is changed. For example, an interactive element/component including, but not limited to a keyboard, a pointing device (e.g., a computer mouse, remote control, etc.), a microphone, a joystick, a tactile input device (e.g., touch screen, gloves, etc.), and/or the like may be used to input data into the data field and/or perform/cause any other change to the data field.

In 314, the changed fields detection module 116 informs the window renderer 118 of the changed data field.

In 316, the window renderer 118 generates, renders, and/or causes to be displayed a changed fields window that includes a previous representation (e.g., copy, reflection, presentation, etc.) of the changed data field (e.g., a presented before the change, etc.). The window renderer 118 also generates, renders, and/or causes to be displayed an inaccessible fields window. The inaccessible fields window includes data fields representative of any data fields that depend on the value/data of other data fields that are no longer applicable, have become read-only (and/or the like), and/or have disappeared from a current view, screen, page, form, and/or the like of the user interface, for example, based on the changed data field.

According to some aspects, the changed fields window may indicate a sequencing element associated with the data field of the changed fields window. The sequencing element may indicate a sequence and/or order of when the change to the data in the data field of the user interface is received.

According to some aspects, the changed fields detection module 116 attaches (e.g., associates, encodes, etc.) event listeners that monitor interactions with and/or the position of sequencing elements of the changed fields window. For example, event listeners may detect, determine, and/or identify a location/position of a sequencing element, and/or detect, determine, and/or identify an interaction (e.g., via the interactive element/component, etc.) with a sequencing element.

In 318, the changed fields detection module 116 informs the indicator element renderer 120 of an interaction with a sequencing element of the changed fields detection module 116.

In 320, the indicator element renderer 120 generates, renders, and/or causes the display of an indicator element (e.g., an arrow, a dotted line, etc.) that indicates correspondence between the sequencing element (and the data field of the changed fields window) and the changed data field of the user interface. According to some aspects, the indicator element renderer 120 uses scalable vector graphics (SVG) and/or the like to generate, render, and/or cause the display of the indicator element.

According to some aspects, the indicator element renderer 120 may adjust the indicator element to a changed location/position of the changed data field of the user interface. For example, according to some aspects, the indicator element renderer 120 may use indications from event listeners to adjust and/or correct an angle of connection between the changed data field of the user interface and the data field of a changed fields window whenever a scroll (e.g., scroll up, scroll down, scroll left, scroll right, etc.), view/screen adjustment, and/or the like of the user interface causes the location/position of the changed data field to change.

In 322, the changed fields detection module 116 informs the window renderer 118 when the changed data field of the user interface is changed and/or reverted to its original value and/or data input. For example, the interactive element/component may be used to change and/or revert the changed data field of the user interface back to its original value and/or data input.

In 324, the window renderer 118 may modify the changed fields window and the inaccessible fields window. For example, the window renderer 118 may remove the data field from the changed fields window that corresponded to the changed data field of the user interface since the changed data field is changed/reverted to its original value and/or data input. The window renderer 118 may remove any data fields representative of data fields that depend on the value/data of other data fields that became no longer applicable, became read-only (and/or the like), and/or disappeared from a current view, screen, page, form, and/or the like of the user interface, for example, since the changed data field is changed/reverted to its original value and/or data input. Additionally, any indicator element corresponding to the changed data field of the user interface may be removed since the changed data field is changed/reverted to its original value and/or data input.

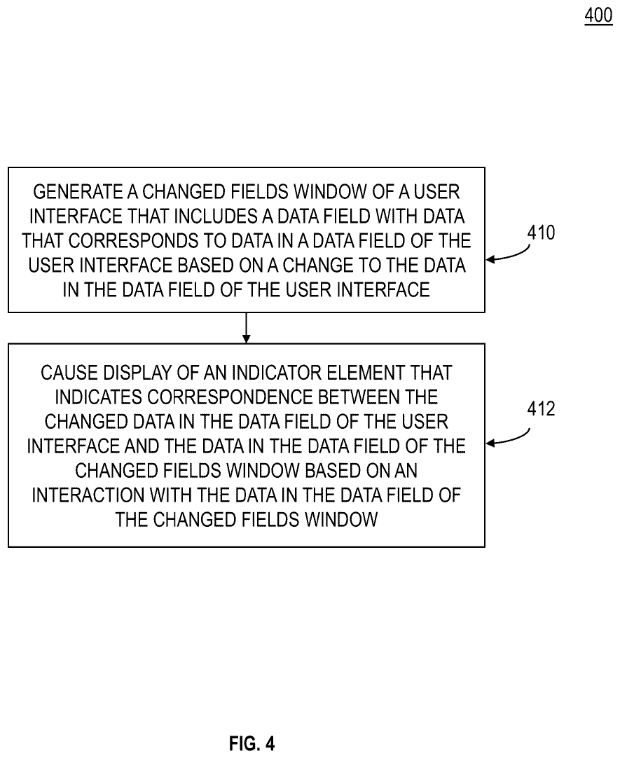

FIG. 4 shows a flowchart of an example method 400 for tracking changes to data fields of a user interface, according to some aspects. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Method 400 shall be described with reference to FIGS. 1-3. However, method 400 is not limited to the aspects of those figures.

In 410, user device 104 generates a changed fields window (e.g., a pop-up window, a block, an interface of any shape, a specialized pop-up window/block, etc.) of a user interface. For example, the user device 104 may generate, launch, and/or cause to be displayed in a user interface. The user interface may be, for example, a complex form used to configure a target device and/or the like. The user interface may be any type of user interface including, but not limited to, a web form, a configuration screen, and/or the like. The data field may be one of a plurality of data fields to which data and/or information may be input.

The user device 104 may generate the changed fields window based on a change to the data in the data field. The user device 104 may generate the changed fields window interface to track the change to the data in the data field. Data in a data field of the changed fields window may correspond to the data in the data field of the user interface. According to some aspects, the changed fields window may indicate a sequencing element associated with the data field of the changed fields window. The sequencing element may indicate a sequence and/or order of when the change to the data in the data field of the user interface is received (e.g., the order in which changes are made to the plurality of data fields of the user interface, etc.).

In 412, user device 104 causes display of an indicator element that indicates correspondence between the changed data in the data field of the user interface and the data in the data field of the changed fields window. According to some aspects, the user device 104 may cause display of the indicator element based on an interaction with the data in the data field of the changed fields window and/or the sequencing element associated with the data field of the changed fields window. The interaction with the data in the data field of the changed fields window and/or the sequencing element may be caused by an interactive element. The interactive element may include, for example, a mouse, a curser, a haptic interface, a user-controlled indicator, and/or the like. The indicator element may include, for example, a dotted line, an arrow, and/or the like. The indicator element may be displayed as an overlay of at least a portion of the user interface.

According to some aspects, the method 400 may include the user device 104 adjusting a position of at least a portion of the indicator element to correspond to the position of the data field of the user interface. For example, the user device 104 may adjust the position of at least the portion of the indicator element to correspond to the position of the data field of the user interface based on the position of the data field of the user interface. According to some aspects, the user device 104 may cause the display of the indicator element to be removed, for example when a position of the data field of the user interface exits a viewable area of the user interface and/or based on an interaction (e.g., a click, a selection, etc.) with the indicator element via the interactive element.

According to some aspects, the method 400 may further include the user device 104 causing data in another data field of the changed fields window to correspond to data in another data field of the user interface. For example, the user device 104 may cause the data in the another data field of the changed fields window to correspond to the data in the another data field of the user interface based on a change to the data in the another data field of the user interface. According to some aspects, a sequence of display of the data field of the changed fields window and the another data field of the changed fields window may correspond to a sequence of the change to the data in the data field and the change to the data in the another data field.

According to some aspects, the method 400 may further include the user device 104 generating an inaccessible fields window of the user interface. For example, the user device 104 may generate the inaccessible fields window based on the change to the data in the data field of the user interface causing another data field of the user interface to at least one of disappear or be modified to a read-only field. According to some aspects, a data field of the inaccessible fields window corresponds to the another data field that at least one of disappeared or became a read-only field.

According to some aspects, the method 400 may further include the user device 104 generating a scrollable element for the data reflection window. For example, the user device 104 may generate the scrollable element for the data reflection window based on fields of additional fields of the data reflection window exceeding a field display threshold for the data reflection window. The scrollable element may include, for example, a scroll bar, a directional arrow(s), a graphical indicator, and/or the like. The user device 104 may cause at least a portion of the fields of the additional fields to be displayed within the data reflection window. For example, the user device 104 may cause at least a portion of the fields of the additional fields to be displayed within the data reflection window based on an interaction with the scrollable element.

According to some aspects, the method 400 may further include the user device 104 sending configuration information to a target device. For example, the user device 104 may send configuration information to a target device based at least in part on change to the data in the data field. For example, once the change to the data in the data field is made, data/information (e.g., configuration information, etc.) indicative of the change may be submitted and/or sent for processing. The submission and processing may include sending the configuration information to the target device.

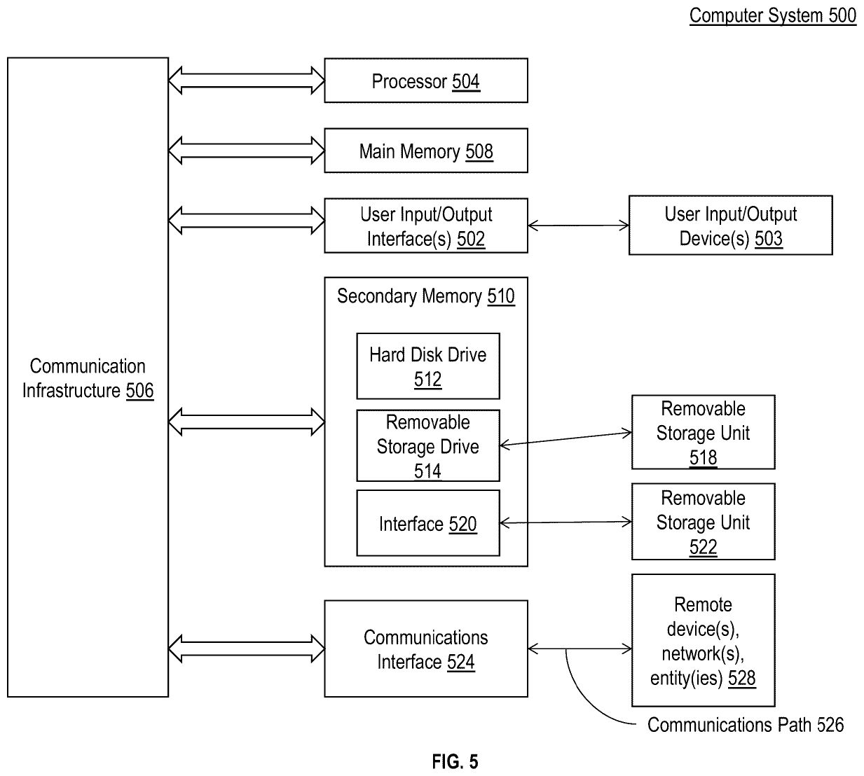

FIG. 5 is an example computer system useful for implementing various embodiments. Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof. According to some aspects, the user device 104 of FIG. 1 (and/or any other device/component described herein) may be implemented using the computer system 500. According to some aspects, the computer system 500 may be used to implement method 400 and/or any other methods and/or steps described herein.

Computer system 500 may include one or more processors (also called central processing units, or CPUs), such as a processor 504. Processor 504 may be connected to a communication infrastructure or bus 506.

Computer system 500 may also include user input/output device(s) 502, such as monitors, keyboards, pointing devices, etc., which may communicate with communication infrastructure or bus 506 through user input/output device(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, a tape backup device, and/or any other storage device/drive.

Removable storage drive 514 may interact with a removable storage unit 518. The removable storage unit 518 may include a computer-usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to the removable storage unit 518.

Secondary memory 510 may include other means, devices, components, instrumentalities, and/or other approaches for allowing computer programs and/or other instructions and/or data to be accessed by computer system 500. Such means, devices, components, instrumentalities, and/or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, and/or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

Additionally and/or alternatively, while this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

One or more parts of the above implementations may include software. Software is a general term whose meaning of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “an aspect,” “aspects,” “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer-implemented method comprising:
generating, based on a change to data in a data field of a user interface, a changed fields window of the user interface to track the change to the data in the data field, wherein data in a data field of the changed fields window corresponds to the data in the data field;
generating an inaccessible fields window of the user interface based on the change to the data in the data field of the user interface causing another data field of the user interface to at least one of disappear or be modified to a read-only field,
wherein a data field of the inaccessible fields window corresponds to the another data field, and
wherein the inaccessible fields window is separate from the changed fields window; and
causing, based on a user interaction with the data in the data field of the changed fields window, display of an indicator element that indicates correspondence between the changed data in the data field and the data in the data field of the changed fields window, wherein the indicator element is displayed as an overlay of at least a portion of the user interface.

2. The computer-implemented method of claim 1, further comprising:
generating, based on an amount of fields of the changed fields window exceeding a field display threshold for the changed fields window, a scrollable element for the changed fields window, wherein a user interaction with the scrollable element causes an additional data field of the changed field window to be displayed.

3. The computer-implemented method of claim 1, wherein the user interaction with the data in the data field of the changed fields window further comprises an interaction with a sequencing element associated with the data in the data field of the changed fields window, wherein the sequencing element indicates a sequence of when the change to the data in the data field is received.

4. The computer-implemented method of claim 1, further comprising causing, based on a change to data in another data field of the user interface, data in another data field of the changed fields window to correspond to the data in the another data field of the user interface, wherein a sequence of display of the data field of the changed fields window and the another data field of the changed fields window corresponds to a sequence of the change to the data in the data field and the change to the data in the another data field.

5. The computer-implemented method of claim 1, further comprising adjusting, based on a position of the data field of the user interface, a position of at least a portion of the indicator element to correspond to the position of the data field of the user interface.

6. The computer-implemented method of claim 1, further comprising causing, based on an interaction with the indicator element via an interactive element, the indicator element to be removed from the user interface.

7. The computer-implemented method of claim 1, further comprising sending, based at least in part on change to the data in the data field, configuration information to a target device.

8. A non-transitory computer-readable medium having instructions stored thereon that, when executed by at least one computing device, causes the at least one computing device to perform operations comprising:
generating, based on a change to data in a data field of a user interface, a changed fields window of the user interface to track the change to the data in the data field, wherein data in a data field of the changed fields window corresponds to the data in the data field;
generating, based on the change to the data in the data field of the user interface causing another data field of the user interface to at least one of disappear or be modified to a read-only field, an inaccessible fields window of the user interface,
wherein a data field of the inaccessible fields window corresponds to the another data field, and
wherein the inaccessible fields window is separate from the changed fields window; and
causing, based on a user interaction with the data in the data field of the changed fields window, display of an indicator element that indicates correspondence between the changed data in the data field and the data in the data field of the changed fields window, wherein the indicator element is displayed as an overlay of at least a portion of the user interface.

9. The non-transitory computer-readable medium of claim 8, the operations further comprising:
generating, based on an amount of fields of the changed fields window exceeding a field display threshold for the changed fields window, a scrollable element for the changed fields window, wherein a user interaction with the scrollable element causes an additional data field of the changed field window to be displayed.

10. The non-transitory computer-readable medium of claim 8, wherein the user interaction with the data in the data field of the changed fields window further comprises an interaction with a sequencing element associated with the data in the data field of the changed fields window, wherein the sequencing element indicates a sequence of when the change to the data in the data field is received.

11. The non-transitory computer-readable medium of claim 8, the operations further comprising causing, based on a change to data in another data field of the user interface, data in another data field of the changed fields window to correspond to the data in the another data field of the user interface, wherein a sequence of display of the data field of the changed fields window and the another data field of the changed fields window corresponds to a sequence of the change to the data in the data field and the change to the data in the another data field.

12. The non-transitory computer-readable medium of claim 8, the operations further comprising adjusting, based on a position of the data field of the user interface, a position of at least a portion of the indicator element to correspond to the position of the data field of the user interface.

13. The non-transitory computer-readable medium of claim 8, the operations further comprising causing, based on an interaction with the indicator element via an interactive element, the indicator element to be removed from the user interface.

14. The non-transitory computer-readable medium of claim 8, the operations further comprising sending, based at least in part on change to the data in the data field, configuration information to a target device.

15. A system comprising:
a memory; and
at least one processor coupled to the memory and configured to perform operations comprising:
generating, based on a change to data in a data field of a user interface, a changed fields window of the user interface to track the change to the data in the data field, wherein data in a data field of the changed fields window corresponds to the data in the data field;
generating an inaccessible fields window of the user interface based on the change to the data in the data field of the user interface causing another data field of the user interface to at least one of disappear or be modified to a read-only field,
wherein a data field of the inaccessible fields window corresponds to the another data field, and
wherein the inaccessible fields window is separate from the changed fields window; and
causing, based on a user interaction with the data in the data field of the changed fields window, display of an indicator element that indicates correspondence between the changed data in the data field and the data in the data field of the changed fields window, wherein the indicator element is displayed as an overlay of at least a portion of the user interface.

16. The system of claim 15, the operations further comprising:
generating, based on an amount of fields of the changed fields window exceeding a field display threshold for the changed fields window, a scrollable element for the changed fields window, wherein an interaction with the scrollable element causes an additional data field of the changed field window to be displayed.

17. The system of claim 15, wherein the user interaction with the data in the data field of the changed fields window further comprises an interaction with a sequencing element associated with the data in the data field of the changed fields window, wherein the sequencing element indicates a sequence of when the change to the data in the data field is received.

18. The system of claim 15, the operations further comprising causing, based on a change to data in another data field of the user interface, data in another data field of the changed fields window to correspond to the data in the another data field of the user interface, wherein a sequence of display of the data field of the changed fields window and the another data field of the changed fields window corresponds to a sequence of the change to the data in the data field and the change to the data in the another data field.

19. The system of claim 15, the operations further comprising adjusting, based on a position of the data field of the user interface, a position of at least a portion of the indicator element to correspond to the position of the data field of the user interface.

20. The system of claim 15, the operations further comprising causing, based on an interaction with the indicator element via an interactive element, the indicator element to be removed from the user interface.
